(19) United States
(12) Patent Application Publication
(10) Pub. No.: US 2012/0137956 A1
(43) Pub. Date: Jun. 7, 2012

(54) WHISTLE

(76) Inventor: Chin-San CHENG, Changhua City (TW)

(21) Appl. No.: 12/961,739

(22) Filed: Dec. 7, 2010

(51) Int. Cl. G10K 5/00

(52) U.S. Cl. 116/137 R

(57) ABSTRACT

The present invention relates to a whistle, comprises a hollow main body, one end of the main body is installed with a mouth part allowing air to be introduced, an accommodation room is concavely installed in any location of the main body but not the location where the mouth part is installed, and a mobile cover is installed and served to engage and seal the accommodation room, and a resonance chamber is formed in the main body, the main body has an opening for allowing a tuning member to be installed, and a fastening cover board is installed and served to seal the opening of the main body; through installing the accommodation room in the main body of the whistle, emergency items such as an emergency contact list, medicines or other emergency information can be stored, so the operation effect of safety function of the whistle is enhanced.

### BACKGROUND OF THE INVENTION

1. Field of the Invention

The present invention relates to a whistle, especially to a whistle capable of enhancing the operation effect of safety function when emergency situations occur.

2. Description of Related Art

A conventional whistle is often made through projection molding, and has a whistle main body in which a resonance chamber is formed, and a fixed partition sheet is installed in the resonance chamber for generating a fixed sound frequency; as such, in emergency situations such as disasters happed in mountains and illness attach which are needed to quickly react, a general whistle is not able to provide in time rescue or assistant information, e.g. the victim or injured personnel's information, rescue information, or even medicines for heart related diseases or for asthma. So when in actual use, the general whistle can not provide in time and efficient assistance in emergency situations. Moreover, when each kind of whistle is manufactured, the manufacturing has to be precise; otherwise after the injection molding, the sound frequency of the whistle can not be adjusted or tuned so inconvenience is generated during the manufacturing.

### SUMMARY OF THE INVENTION

The applicant of the present invention has discovered that a conventional whistle, in actual use, is not able to increase the operation effect of safety function in emergency situations and the manufacturing thereof has some disadvantages which shall be improved.

One primary object of the present invention is to provide a whistle equipped with an enhanced operation effect of safety function in emergency situations.

Another object of the present invention is to provide a whistle, which can lower the production cost.

For achieving the mentioned objects, one solution according to the present invention is to provide a whistle, comprises a main body, the main body is designed to be hollow, and an accommodation room is concavely formed in the main body, a mobile cover is installed and engaged with the accommodation room, and a resonance chamber is formed in the main body, one end of the main body has a mouth part in which an air channel is formed, and a tuning fork is installed between the air channel and the resonance chamber, two ends of the main body at the resonance chamber are respectively installed with a sound outlet, and one surface of the main body is formed with an opening, a tuning member is installed in the resonance chamber of the main body, and one end of the tuning member is connected to the main body and the other end thereof is connected to the tuning fork, and a fastening cover board is installed and served to seal the opening of the main body.

### BRIEF DESCRIPTION OF THE DRAWINGS

FIG. 1 is a perspective view showing the appearance of one embodiment of the present invention;

FIG. 2 is a perspective exploded view showing the components according to the present invention;

FIG. 3 is a cross sectional view showing the assembly of the present invention;

FIG. 4 is a schematic perspective view showing the present invention being in an operating state;

FIG. 5 is a perspective exploded view showing the mobile cover according to another embodiment of the present invention;

FIG. 6 is a schematic perspective view showing FIG. 5 being in an operating state;

FIG. 7 is a perspective exploded view showing the mobile cover according to one another embodiment of the present invention;

FIG. 8 is a schematic perspective view showing FIG. 7 being in an operating state;

FIG. 9 is perspective view showing the appearance of another embodiment of the present invention;

FIG. 10 is a schematic perspective view showing FIG. 9 being in an operating state;

FIG. 11 is a cross sectional view showing the assembly of the tuning member according to the present invention.

### DESCRIPTION OF MAIN COMPONENT SYMBOLS

10`100: main body
11`110`111`112: accommodation room
12`120`121`122: mobile cover
13: resonance chamber
14: mouth part
15: air channel
16: tuning fork
17: embedded slot
18: adjustment part
19: sound outlet
20: tuning member
21: first partition sheet
22: second partition sheet
23: third partition sheet
24: fourth partition sheet
25: connection part
30`300: fastening cover board
40`41: emergency contact list

### DETAILED DESCRIPTION OF THE PREFERRED EMBODIMENT

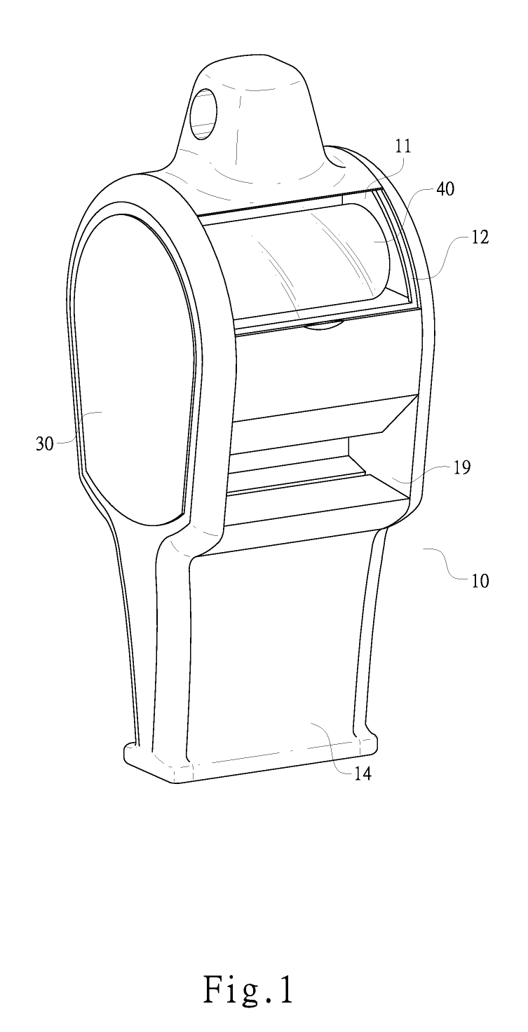

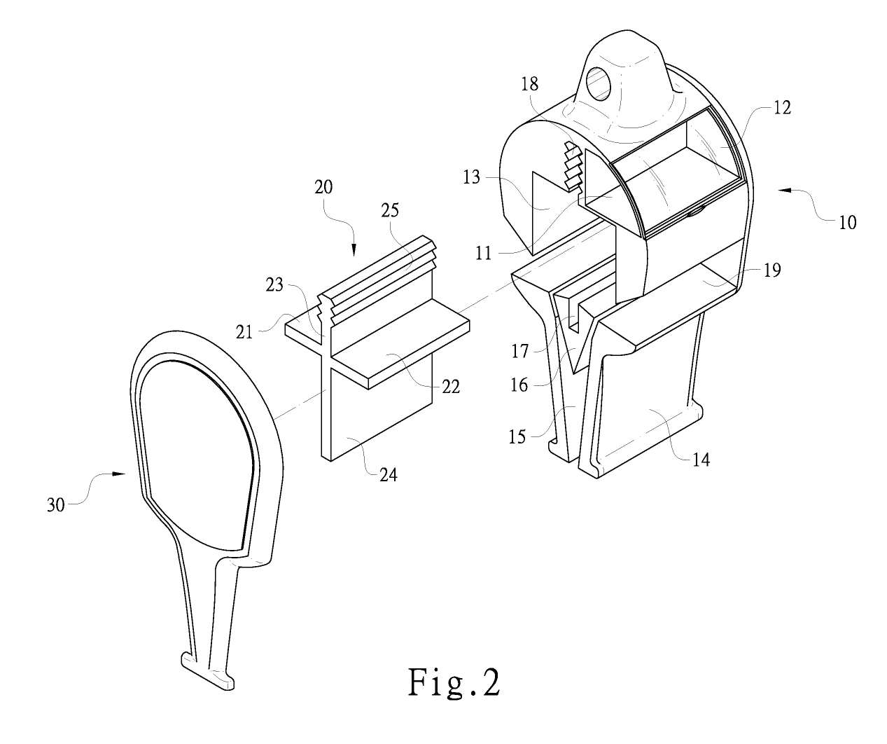

Referring from FIG. 1 to FIG. 3, the whistle provided by the present invention comprises:

a main body 10, the main body 10 is designed to be hollow and one end thereof is concavely formed with an accommodation room 11, a mobile cover 12 is installed and served to cover the accommodation room 11, the mobile cover 12 is a transparent liftable mobile cover, and the interior of the main body 10 is formed with a resonance chamber 13, a mouth part 14 allowing air to be introduced is installed at one end of the main body 10 opposite to the end where the accommodation room 11 is formed, an air channel 15 is formed in the mouth part 14, and a reversed-triangular tuning fork 16 is installed between the air channel 15 and the resonance chamber 13, and an embedded slot 17 is installed on the tuning fork 16 towards the resonance chamber 13, the main body 10 is concavely installed with an adjustment part 18 having inner teeth, the adjustment part 18 is installed with respect to the embedded slot 17, and two ends of the main body 10 at the resonance chamber 13 are respectively installed with a sound outlet 19, and the air channel 15, the resonance chamber 13 and the sound outlets 19 are communicated with each other, and one surface of the main body 10 is formed with an opening (not shown);

a tuning member 20, the tuning member 20 is received in the resonance chamber 13 of the main body 10 and formed in a crisscross shape so as to be formed with four partition sheets which are respectively defined as a first partition sheet 21, a second partition sheet 22, a third partition sheet 23 and a fourth partition sheet 24; the first partition sheet 21 and the second partition sheet 22 are parallel but not on the same plane, and the third partition sheet 23 is installed with a connection part 25, which is in a tooth shape, with respect to the adjustment part 18 of the main body 10 such that the connection part 25 can be engaged with the adjustment part 18 of the main body 10, and a distal end of the fourth partition sheet 24 is received in the embedded slot 17 of the tuning fork 16; and

A fastening cover board 30, the fastening cover board 30 is served to seal the opening of the main body 10; accordingly, the whistle provided by the present invention is assembled through the mentioned structure.

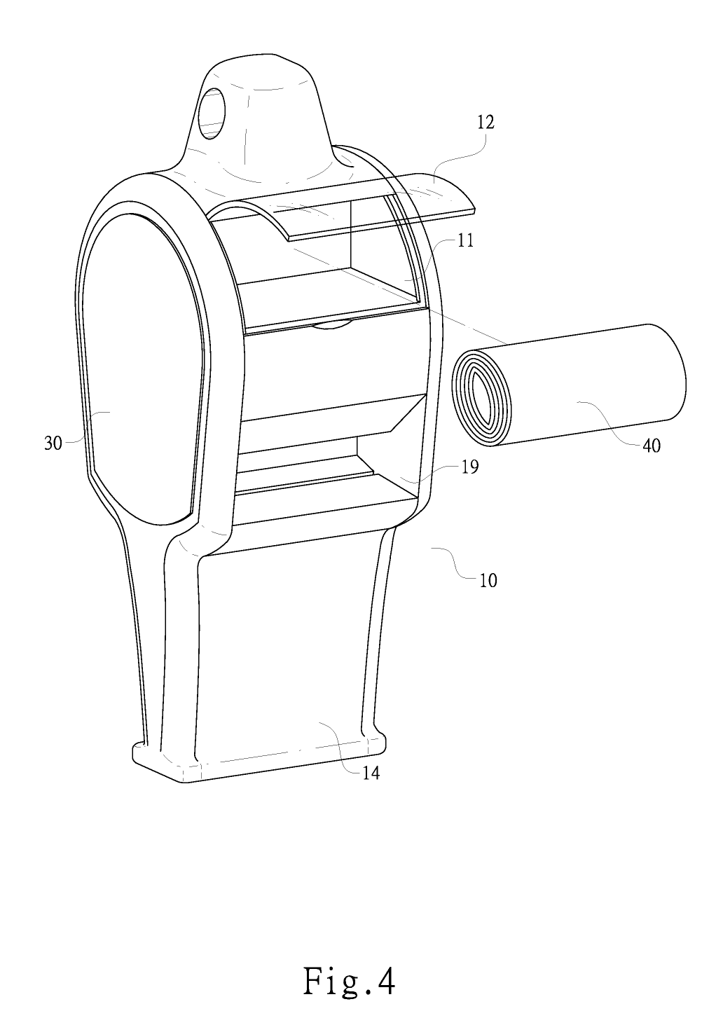

When in use, as shown in FIG. 1 and FIG. 4, the mobile cover 12 can be opened so a user can place in items which can be used in emergency situations, e.g. an emergency contact list, medications or other emergency information; as shown in figures, an emergency contact list 40 is provided as an emergency information document which may be written with emergency telephone numbers, medical history, or address; the emergency contact list 40 can be rolled and placed in the accommodation room 11 of the main body 10 from the mobile cover 12, then the mobile cover 12 is engaged with the accommodation room 11, such that the items stored in the whistle can be seen through the transparent mobile cover 12, and when emergency situations occur, for example elder people are lost, disasters happed in mountains or other accidents, other people can provide their assistance, so the operation effect of safety function of the whistle is enhanced.

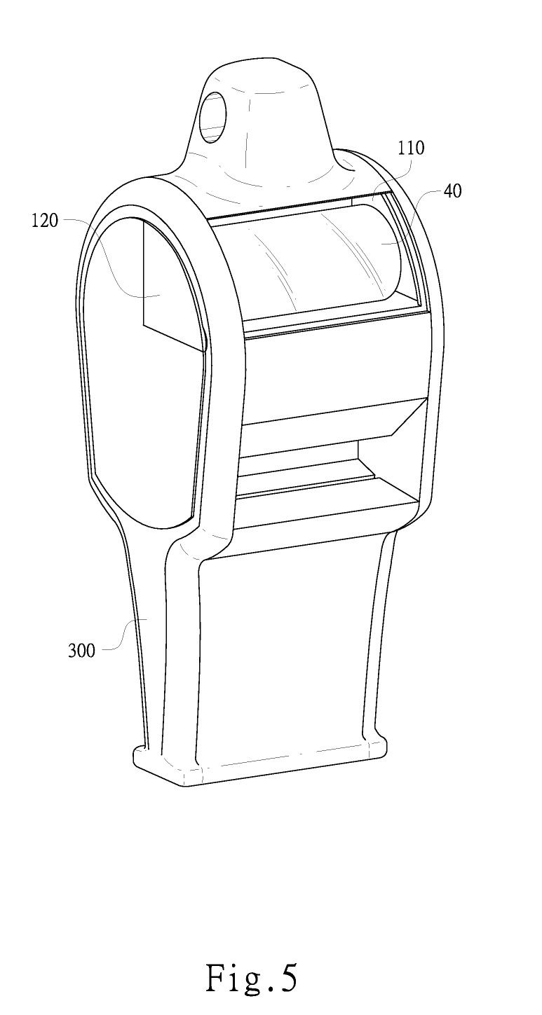

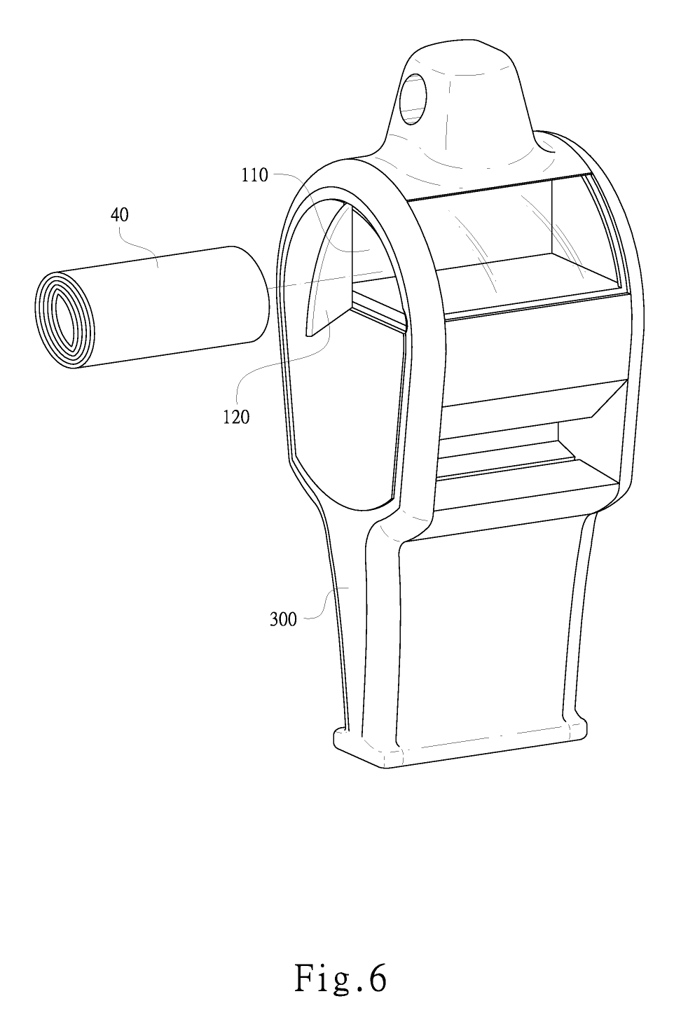

As shown in FIG. 5 and FIG. 6, which are schematic views showing the mobile cover according to another embodiment of the present invention, a fastening cover board 300 is installed with another mobile cover 120 with respect to the location of an accommodation room 110, the another mobile cover 120 can also be served to allow a user to place emergency items in the accommodation chamber 110.

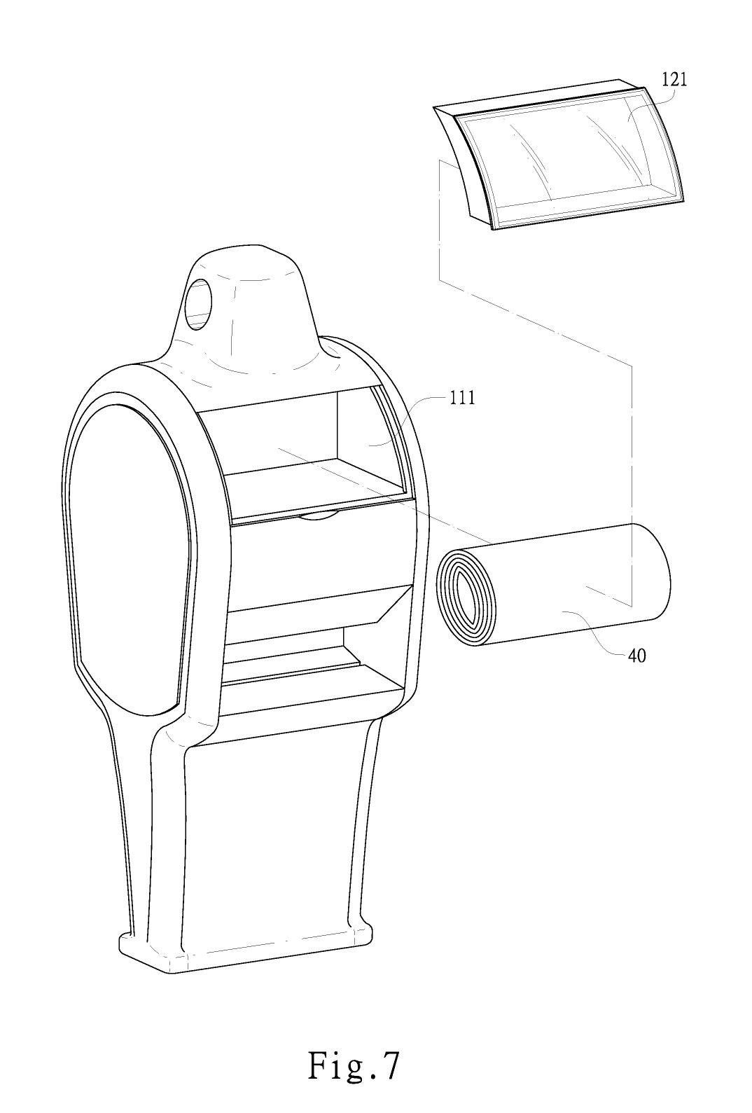

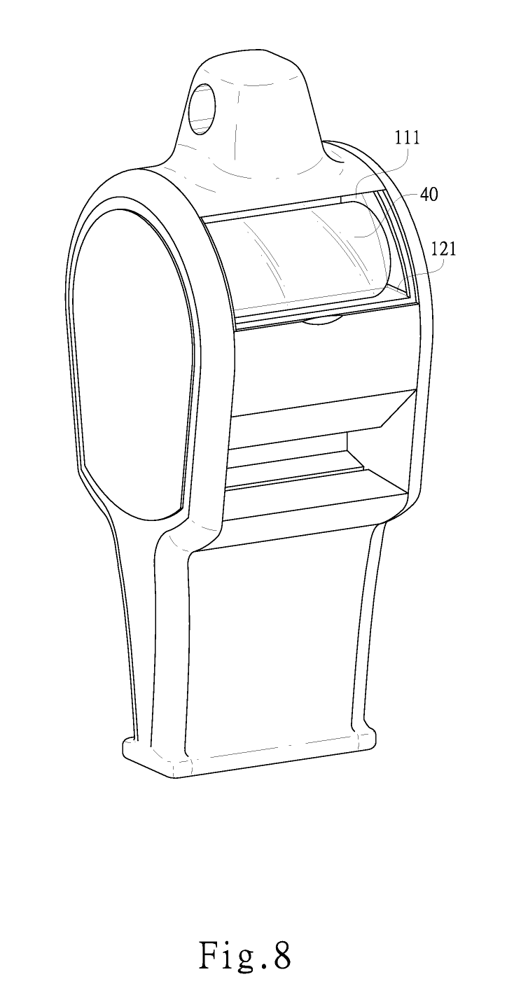

As shown in FIG. 7 and FIG. 8, which are schematic views showing the mobile cover according to one another embodiment of the present invention, wherein a mobile cover 121 is an embedded cover board, so after the emergency contact list 40 is placed in an accommodation room 111, the mobile cover 121 is embedded in the accommodation room 111, such that the emergency contact list 40 is stored between a space defined by the accommodation room 111 and the mobile cover 121.

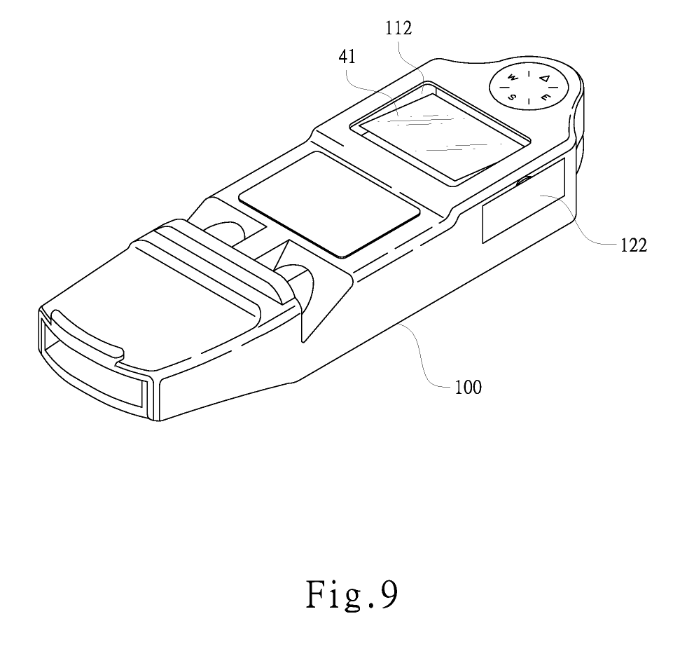

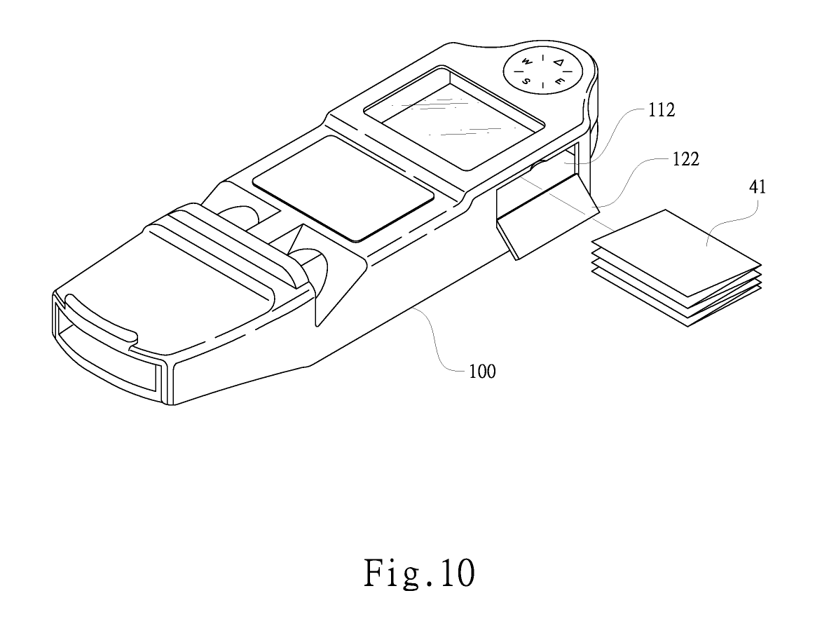

As shown in FIG. 9 and FIG. 10, which are schematic views showing the main body according to another embodiment of the present invention, a main body 100 is formed in an elongated shape and is also provided with at least one mobile cover 122, so an emergency contact list 41 can be received in an accommodation room 112 for increasing the operation effect.

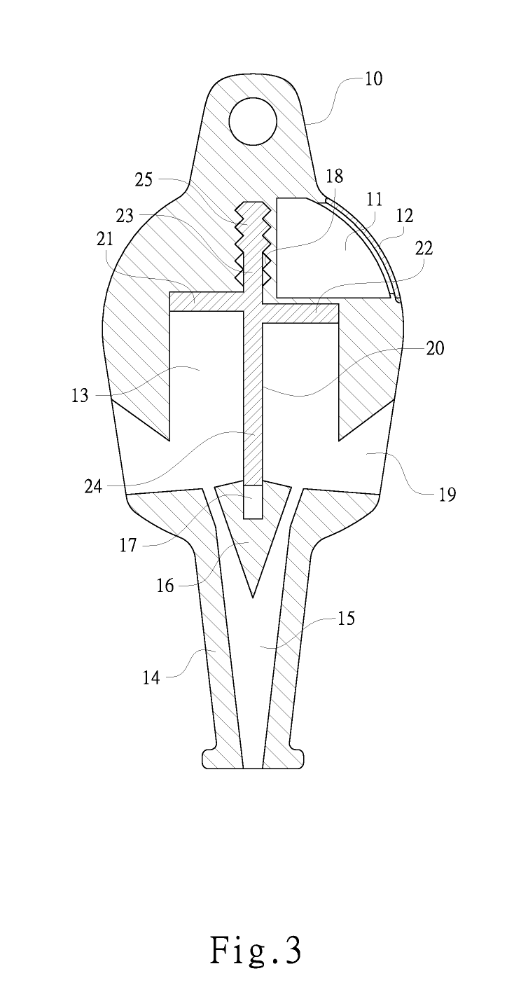

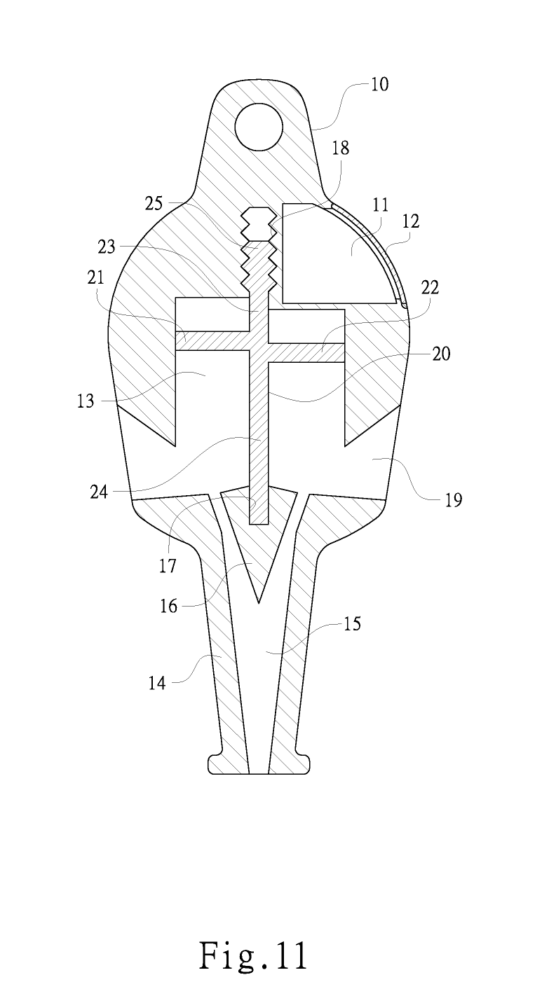

As shown in FIG. 3 and FIG. 11, when the whistle is manufactured, the engaging location where the connection part 25 of the tuning member 20 and the adjustment part 18 of the main body 10 are engaged can be adjusted so as to adjust the heights of the first partition sheet 21 and the second partition sheet 22 of the tuning member 20 relative to the tuning fork 16, such that the space of the resonance chamber 13 of the main body 10 is altered for adjusting the sound frequency of the whistle; and during the manufacturing, the whistle is easy to be manufactured, and through adjusting the location of the tuning member 20 according to the desired sound frequency, there is no need of providing additional molds for meeting different sound frequencies, then the fastening cover board 30 is served to seal the opening of the main body 10, the assembly of the whistle is therefore finished, and the object of greatly reducing the production cost of the whistle is achieved.

Although the present invention has been described with reference to the preferred embodiments thereof, it is apparent to those skilled in the art that a variety of modifications and changes may be made without departing from the scope of the present invention which is intended to be defined by the appended claims

What is claimed is:

1. A whistle, comprises:
a main body, the main body is hollow and an accommodation room is concavely formed in the main body, a mobile cover is installed and engaged with the accommodation room, and a resonance chamber is formed in the main body, one end of the main body has a mouth part in which an air channel is formed, a tuning fork is installed between the air channel and the resonance chamber, at least one end of the main body at the resonance chamber is installed with a sound outlet, and the air channel, the resonance chamber and the sound outlet are communicated with each other, and one surface of the main body is formed with an opening;
a tuning member, the tuning member is installed in the resonance chamber of the main body, and one end of the tuning member is connected to the main body and the other end thereof is connected to the tuning fork; and
a fastening cover board, the fastening cover board is served to seal the opening of the main body.

2. The whistle as claimed in claim 1, wherein the mobile cover is a mobile liftable cover.

3. The whistle as claimed in claim 1, wherein the mobile cover is an embedded cover board.

4. The whistle as claimed in claim 1, wherein the mobile cover is transparent.

5. The whistle as claimed in claim 2, wherein the mobile cover is transparent.

6. The whistle as claimed in claim 3, wherein the mobile cover is transparent.

7. The whistle as claimed in claim 1, wherein an embedded slot is installed on the tuning fork towards the resonance chamber.

8. The whistle as claimed in claim 1, wherein an embedded slot is installed on the tuning fork towards the resonance chamber, and the main body is concavely installed with an adjustment part having inner teeth, the adjustment part is installed with respect to the embedded slot, the tuning member is formed in a crisscross shape so as to be formed with four partition sheets which are respectively defined as a first partition sheet, a second partition sheet, a third partition sheet and a fourth partition sheet;
the first partition sheet and the second partition sheet are in parallel, and the third partition sheet is installed with a connection part, which is in a tooth shape, with respect to the adjustment part of the main body such that the connection part is enabled to be engaged with the adjustment part of the main body, and a distal end of the fourth partition sheet is received in the embedded slot of the tuning fork.

9. The whistle as claimed in claim 6, wherein the first partition sheet and the second partition sheet are not on the same plane.

10. The whistle as claimed in claim 1, wherein the fastening cover board is installed with another mobile cover with respect to the location of the accommodation room.

11. The whistle as claimed in claim 1, wherein the quantity of the sound outlet is two, and the two sound outlets are respectively installed at the two ends of the main body at the resonance chamber.
